(19) United States
(12) Patent Application Publication
(10) Pub. No.: US 2011/0285056 A1
(43) Pub. Date: Nov. 24, 2011

(54) METHOD AND APPARATUS FOR PRODUCING A ROTOR BLADE

(76) Inventors: Lars DAVIDEIT, Hasbergen (DE); Andreas Starke, Rheine (DE)

(21) Appl. No.: 12/971,969

(22) Filed: Dec. 17, 2010

(51) Int. Cl. B29C 53/14; B29C 70/00

(52) U.S. Cl. 264/299; 425/334

(57) ABSTRACT

A tool for producing a rotor blade comprises at least one mold, and at least one supporting structure for the at least one mold. The mold is supported by a support structure, wherein the support structure is adapted such that a twist angle of at least one portion of the mold is adjustable. Further, a method for varying a twist angle of a rotor blade is provided.

### BACKGROUND OF THE INVENTION

The subject matter described herein relates generally to methods and systems for the production of rotor blades, and more particularly, to methods and systems for producing rotor blades for wind turbines.

At least some known wind turbines include a tower and a nacelle mounted on the tower. A rotor is rotatably mounted to the nacelle and is coupled to a generator by a shaft. A plurality of blades extend from the rotor. The blades are oriented such that wind passing over the blades turns the rotor and rotates the shaft, thereby driving the generator to generate electricity.

Rotor blades for wind turbines are typically produced by laminating a structure into a prefabricated mold. The mold itself typically comprises an upper and a lower part, which are subsequently laminated together. The boundary between the halves is typically at the front edge (leading edge) and the back edge (trailing edge) of the blade profile.

The shape of the mold defines properties of the produced rotor blade like length, width, thickness, sweep, prebend, and twist angle. The mold itself typically comprises compound materials like fiberglass, carbon fiber, or combinations thereof. Furthermore, the mold is relatively easy to deform and is thus stabilized by a support structure typically comprising steel elements during the production process.

Typically, the tooling process for producing the mold is time-consuming and requires a significant amount of handwork. The above described parameters of the mold determine the properties and quality of the produced blade. If it shows after production of the first rotor blades that the produced blades do not exhibit satisfying performance, a cumbersome and expensive reworking of the mold may be necessary.

This problem is particularly important in view of rotor blades with a so called twist bend coupling. Wind turbine blade designs with twist bend coupling have been shown to reduce gust-induced extreme and fatigue loads. In general terms, the concept is to allow the blade to unload by coupling the blade bending moment with the twist rotation. Increments in bending moment produce an increment in the twist that reduces the aerodynamically induced load.

It has shown that the coupling coefficient between bending of an outer region of a rotor blade during gusts and an induced change of a twist angle is dependent on a number of factors. The coupling factor between the parameters involved is difficult to take into account during the design phase. Hence, the actual coupling properties of a rotor blade may only show after a first blade is produced. If, during subsequent testing, it shows that the twist bend coupling is unsatisfactory, it may be necessary to change the static twist angle, that is, changing its distribution over the length of the blade by varying the mold or at least parts of it. However, due to the above reasons, this is a cumbersome process.

In view of the above, there is a desire for a method and tool for producing a rotor blade which allow for an easy modification of a mold for a wind turbine.

### BRIEF DESCRIPTION OF THE INVENTION

In one aspect, a tool for producing a rotor blade is provided. The tool includes at least one mold, and at least one supporting structure for the at least one mold. The at least one mold is supported by the support structure, and the support structure is adapted such that a twist angle of at least one portion of the at least one mold is adjustable.

In another aspect, a method for varying a twist angle of a part of a rotor blade is provided. The method includes providing a tool for producing a rotor blade, including at least one mold, and at least one supporting structure for the at least one mold. The mold is supported by the support structure, and the support structure is adapted such that a twist angle of at least one portion of the mold is adjustable. The method further includes adjusting the tool such that the twist angle of a portion of the mold is modified.

Further aspects, advantages and features of the present invention are apparent from the dependent claims, the description and the accompanying drawings.

### BRIEF DESCRIPTION OF THE DRAWINGS

A full and enabling disclosure including the best mode thereof, to one of ordinary skill in the art, is set forth more particularly in the remainder of the specification, including reference to the accompanying figures wherein:

FIG. 1 is a perspective view of an exemplary wind turbine.

FIG. 2 is an enlarged sectional view of a portion of the wind turbine shown in FIG. 1.

FIG. 3 is a perspective view of a tool according to embodiments.

FIGS. 4 to 6 are sectional views of the tool of FIG. 3 according to embodiments.

FIG. 7 is a perspective view of a tool according to further embodiments.

FIG. 8 is a sectional view of the tool of FIG. 7 along line B.

FIG. 9 is a further sectional view of the tool of FIG. 7

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

The embodiments described herein include a tool for producing a rotor blade that allows for a modification of a twist angle of the rotor blade during production.

As used herein, the term chord line is intended to be representative of a line which connects the leading edge and the trailing edge of a profile at a given position along the length of the rotor blade. As used herein, the term “twist angle” is intended to be representative, at a given position along the length of the rotor blade, of the angle between the chord line and the rotation plane. Typically, the twist angle varies between different sections or regions of a rotor blade. As a non-limiting example, the twist angle may be between 15° to 20° in the region of the blade exhibiting the largest chord, whereas in the tip region, the angle may be about −2° to 0°. The design of a rotor blade is significantly determined by the size and evolution of the twist angle along the length of the blade. Accordingly, as used herein, the term “adjusting a twist angle” is intended to be representative of an adjustment of a direction of a chord line in at least one region of a rotor blade during production of the same. Differently expressed, “adjusting a twist angle” means modifying a shape of a rotor blade during production by distorting one portion of the blade, with respect to a longitudinal axis, against another portion of the blade, wherein the modification is at most from −10° to 20°, or more specifically, from 0° to 20°, or even more specifically, from 0° to 10°.

As used herein, the term “blade” is intended to be representative of any device that provides a reactive force when in motion relative to a surrounding fluid. As used herein, the term “wind turbine” is intended to be representative of any device that generates rotational energy from wind energy, and more specifically, converts kinetic energy of wind into mechanical energy. As used herein, the term “wind generator” is intended to be representative of any wind turbine that generates electrical power from rotational energy generated from wind energy, and more specifically, converts mechanical energy converted from kinetic energy of wind to electrical power. As used herein,

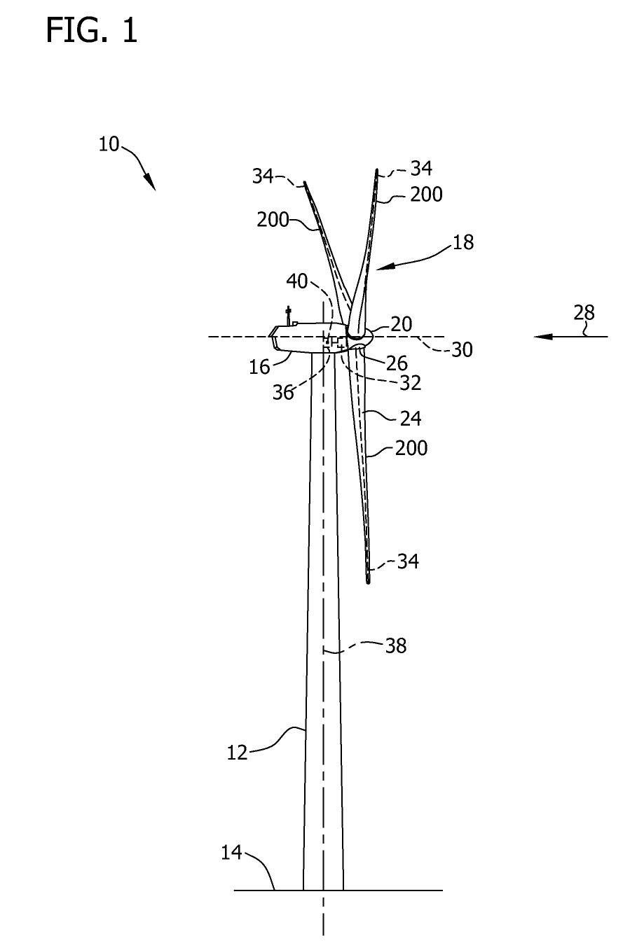

FIG. 1 is a perspective view of an exemplary wind turbine 10. In the exemplary embodiment, wind turbine 10 is a horizontal-axis wind turbine. Alternatively, wind turbine 10 may be a vertical-axis wind turbine. In the exemplary embodiment, wind turbine 10 includes a tower 12 that extends from a support system 14, a nacelle 16 mounted on tower 12, and a rotor 18 that is coupled to nacelle 16. Rotor 18 includes a rotatable hub 20 and at least one rotor blade 22 coupled to and extending outward from hub 20. In the exemplary embodiment, rotor 18 has three rotor blades 22. In an alternative embodiment, rotor 18 includes more or less than three rotor blades 22. In the exemplary embodiment, tower 12 is fabricated from tubular steel to define a cavity (not shown in FIG. 1) between support system 14 and nacelle 16. In an alternative embodiment, tower 12 is any suitable type of tower having any suitable height.

Rotor blades 22 are spaced about hub 20 to facilitate rotating rotor 18 to enable kinetic energy to be transferred from the wind into usable mechanical energy, and subsequently, electrical energy. Rotor blades 22 are mated to hub 20 by coupling a blade root portion 24 to hub 20 at a plurality of load transfer regions 26. Load transfer regions 26 have a hub load transfer region and a blade load transfer region (both not shown in FIG. 1). Loads induced to rotor blades 22 are transferred to hub 20 via load transfer regions 26.

In one embodiment, rotor blades 22 have a length ranging from about 15 meters (m) to about 91 m. Alternatively, rotor blades 22 may have any suitable length that enables wind turbine 10 to function as described herein. For example, other non-limiting examples of blade lengths include 10 m or less, 20 m, 37 m, or a length that is greater than 91 m. As wind strikes rotor blades 22 from a direction 28, rotor 18 is rotated about an axis of rotation 30. As rotor blades 22 are rotated and subjected to centrifugal forces, rotor blades 22 are also subjected to various forces and moments. As such, rotor blades 22 may deflect and/or rotate from a neutral, or non-deflected, position to a deflected position.

Moreover, a pitch angle or blade pitch of rotor blades 22, i.e., an angle that determines a perspective of rotor blades 22 with respect to direction 28 of the wind, may be changed by a pitch adjustment system 32 to control the load and power generated by wind turbine 10 by adjusting an angular position of at least one rotor blade 22 relative to wind vectors. Pitch axes 34 for rotor blades 22 are shown. During operation of wind turbine 10, pitch adjustment system 32 may change a blade pitch of rotor blades 22 such that rotor blades 22 are moved to a feathered position, such that the perspective of at least one rotor blade 22 relative to wind vectors provides a minimal surface area of rotor blade 22 to be oriented towards the wind vectors, which facilitates reducing a rotational speed of rotor 18 and/or facilitates a stall of rotor 18.

In the exemplary embodiment, a blade pitch of each rotor blade 22 is controlled individually by a control system 36. Alternatively, the blade pitch for all rotor blades 22 may be controlled simultaneously by control system 36. Further, in the exemplary embodiment, as direction 28 changes, a yaw direction of nacelle 16 may be controlled about a yaw axis 38 to position rotor blades 22 with respect to direction 28.

In the exemplary embodiment, control system 36 is shown as being centralized within nacelle 16, however, control system 36 may be a distributed system throughout wind turbine 10, on support system 14, within a wind farm, and/or at a remote control center. Control system 36 includes a processor 40 configured to perform the methods and/or steps described herein. Further, many of the other components described herein include a processor. As used herein, the term “processor” is not limited to integrated circuits referred to in the art as a computer, but broadly refers to a controller, a microcontroller, a microcomputer, a programmable logic controller (PLC), an application specific integrated circuit, and other programmable circuits, and these terms are used interchangeably herein. It should be understood that a processor and/or a control system can also include memory, input channels, and/or output channels.

In the embodiments described herein, memory may include, without limitation, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, input channels include, without limitation, sensors and/or computer peripherals associated with an operator interface, such as a mouse and a keyboard. Further, in the exemplary embodiment, output channels may include, without limitation, a control device, an operator interface monitor and/or a display.

Processors described herein process information transmitted from a plurality of electrical and electronic devices that may include, without limitation, sensors, actuators, compressors, control systems, and/or monitoring devices. Such processors may be physically located in, for example, a control system, a sensor, a monitoring device, a desktop computer, a laptop computer, a programmable logic controller (PLC) cabinet, and/or a distributed control system (DCS) cabinet. RAM and storage devices store and transfer information and instructions to be executed by the processor(s). RAM and storage devices can also be used to store and provide temporary variables, static (i.e., non-changing) information and instructions, or other intermediate information to the processors during execution of instructions by the processor(s). Instructions that are executed may include, without limitation, wind turbine control system control commands. The execution of sequences of instructions is not limited to any specific combination of hardware circuitry and software instructions.

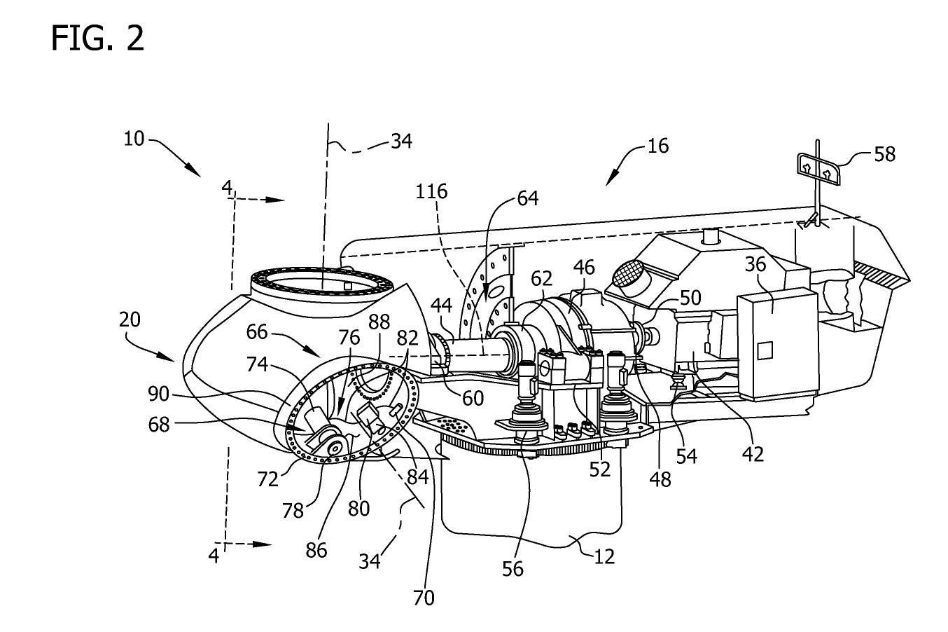

FIG. 2 is an enlarged sectional view of a portion of wind turbine 10. In the exemplary embodiment, wind turbine 10 includes nacelle 16 and hub 20 that is rotatably coupled to nacelle 16. More specifically, hub 20 is rotatably coupled to an electric generator 42 positioned within nacelle 16 by rotor shaft 44 (sometimes referred to as either a main shaft or a low speed shaft), a gearbox 46, a high speed shaft 48, and a coupling 50. In the exemplary embodiment, rotor shaft 44 is disposed coaxial to longitudinal axis 116. Rotation of rotor shaft 44 rotatably drives gearbox 46 that subsequently drives high speed shaft 48. High speed shaft 48 rotatably drives generator 42 with coupling 50 and rotation of high speed shaft 48 facilitates production of electrical power by generator 42. Gearbox 46 and generator 42 are supported by a support 52 and a support 54. In the exemplary embodiment, gearbox 46 utilizes a dual path geometry to drive high speed shaft 48. Alternatively, rotor shaft 44 is coupled directly to generator 42 with coupling 50.

Nacelle 16 also includes a yaw drive mechanism 56 that may be used to rotate nacelle 16 and hub 20 on yaw axis 38 (shown in FIG. 1) to control the perspective of rotor blades 22 with respect to direction 28 of the wind. Nacelle 16 also includes at least one meteorological mast 58 that includes a wind vane and anemometer (neither shown in FIG. 2). Mast 58 provides information to control system 36 that may include wind direction and/or wind speed. In the exemplary embodiment, nacelle 16 also includes a main forward support bearing 60 and a main aft support bearing 62.

Forward support bearing 60 and aft support bearing 62 facilitate radial support and alignment of rotor shaft 44. Forward support bearing 60 is coupled to rotor shaft 44 near hub 20. Aft support bearing 62 is positioned on rotor shaft 44 near gearbox 46 and/or generator 42. Alternatively, nacelle 16 includes any number of support bearings that enable wind turbine 10 to function as disclosed herein. Rotor shaft 44, generator 42, gearbox 46, high speed shaft 48, coupling 50, and any associated fastening, support, and/or securing device including, but not limited to, support 52 and/or support 54, and forward support bearing 60 and aft support bearing 62, are sometimes referred to as a drive train 64.

In the exemplary embodiment, hub 20 includes a pitch assembly 66. Pitch assembly 66 includes one or more pitch drive systems 68 and at least one sensor 70. Each pitch drive system 68 is coupled to a respective rotor blade 22 (shown in FIG. 1) for modulating the blade pitch of associated rotor blade 22 along pitch axis 34. Only one of three pitch drive systems 68 is shown in FIG. 2.

In the exemplary embodiment, pitch assembly 66 includes at least one pitch bearing 72 coupled to hub 20 and to respective rotor blade 22 (shown in FIG. 1) for rotating respective rotor blade 22 about pitch axis 34. Pitch drive system 68 includes a pitch drive motor 74, pitch drive gearbox 76, and pitch drive pinion 78. Pitch drive motor 74 is coupled to pitch drive gearbox 76 such that pitch drive motor 74 imparts mechanical force to pitch drive gearbox 76. Pitch drive gearbox 76 is coupled to pitch drive pinion 78 such that pitch drive pinion 78 is rotated by pitch drive gearbox 76. Pitch bearing 72 is coupled to pitch drive pinion 78 such that the rotation of pitch drive pinion 78 causes rotation of pitch bearing 72. More specifically, in the exemplary embodiment, pitch drive pinion 78 is coupled to pitch bearing 72 such that rotation of pitch drive gearbox 76 rotates pitch bearing 72 and rotor blade 22 about pitch axis 34 to change the blade pitch of blade 22.

Pitch drive system 68 is coupled to control system 36 for adjusting the blade pitch of rotor blade 22 upon receipt of one or more signals from control system 36. In the exemplary embodiment, pitch drive motor 74 is any suitable motor driven by electrical power and/or a hydraulic system that enables pitch assembly 66 to function as described herein. Alternatively, pitch assembly 66 may include any suitable structure, configuration, arrangement, and/or components such as, but not limited to, hydraulic cylinders, springs, and/or servo-mechanisms. Moreover, pitch assembly 66 may be driven by any suitable means such as, but not limited to, hydraulic fluid, and/or mechanical power, such as, but not limited to, induced spring forces and/or electromagnetic forces. In certain embodiments, pitch drive motor 74 is driven by energy extracted from a rotational inertia of hub 20 and/or a stored energy source (not shown) that supplies energy to components of wind turbine 10.

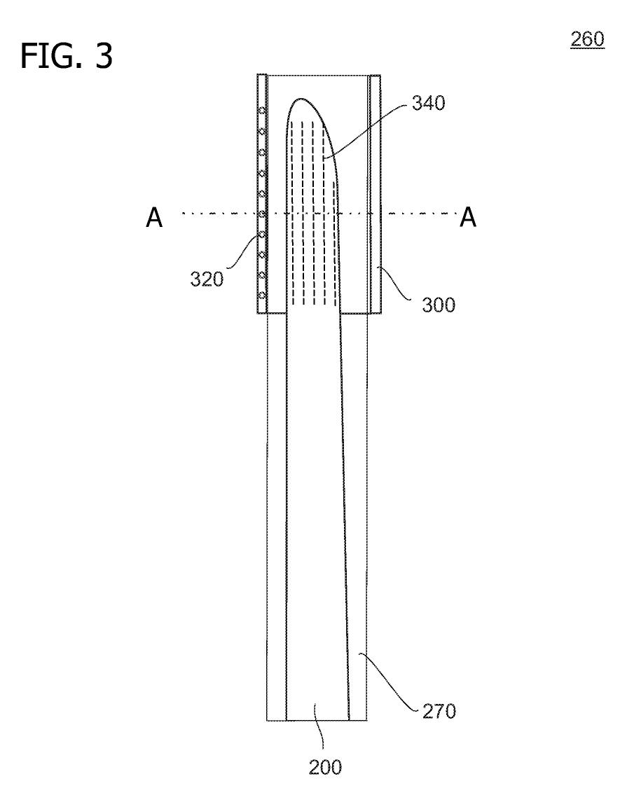

FIG. 3 shows a perspective view of a tool 260 for producing a rotor blade 200 according to embodiments. The tool comprises a mold 270 and a supporting structure 280 (only schematically shown) supporting mold 270. The rotor blade is typically produced by the well-known process of laminating the blade structure into the mold. Typically, the mold is designed such that only one half of the blade is produced, whereby subsequently the two halves are laminated together to form the rotor blade. All embodiments described herein pertain to a mold for one half of a rotor blade.

In the embodiment, in a region of mold 270 which is representative of an outer region of the rotor blade, an adjusting mechanism is provided. The adjusting mechanism is suitable to adjust the twist angle of the respective region of the rotor blade to be produced with respect to other regions of the blade 200.

In the embodiment, the adjustable part of the mold is supported by a hinge 300, about which this part of the mold can be turned. On a side of the mold opposite to the hinge, the mold is supported by a number of height-adjustable posts 320 which may be adjusted in a z-direction, which in FIG. 3 is perpendicular to the plane of the drawing. In the region of the mold where the twist angle is adjustable, which is defined by the length of hinge 300, the mold is further supported by support elements 340.

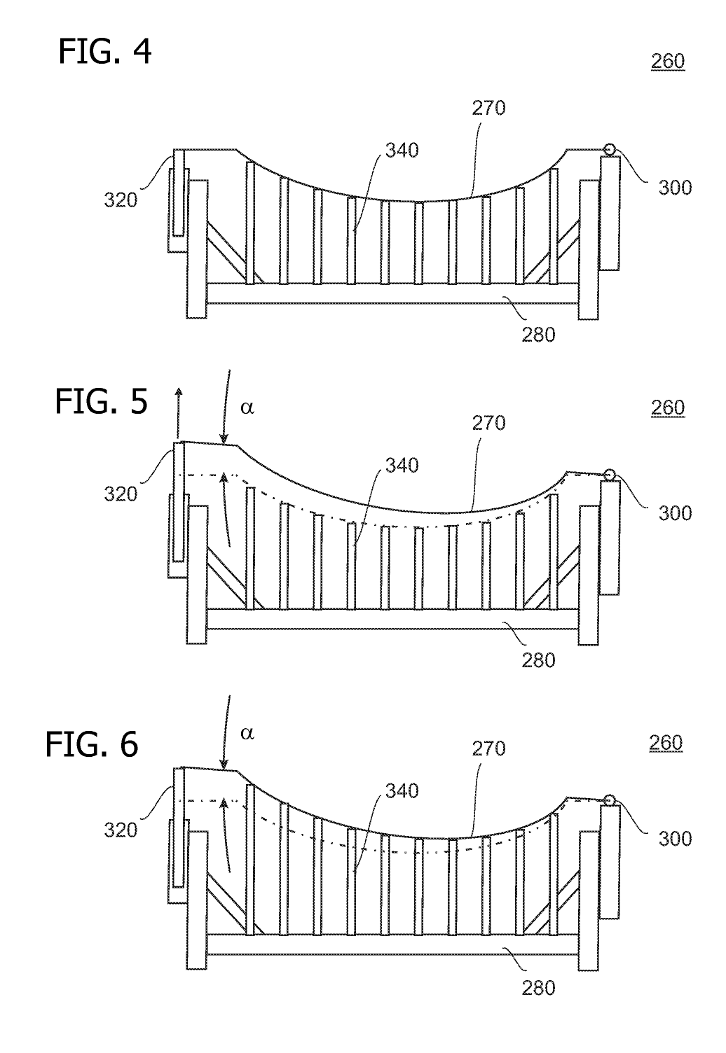

FIGS. 4 to 6 show sectional views of the tool 260 according to the embodiment of FIG. 3 along line A-A. FIG. 4 shows the tool 260 with a non-modified twist angle. Mold 270 is supported on one side by hinge 300, and on the opposite side by posts 320. Support structure 280, typically comprising steel, supports mold 270. Part of the support structure are support elements 340, which are height adjustable. When the twist angle of mold 270 is changed via tool 260, the height of posts 320 is changed, typically increased, which is schematically shown in FIG. 5.

While the side of mold 270 supported by posts 320 is elevated, the other end of the mold supported by hinge 300 remains at the same height. The resulting height difference between both sides provides for an inclination of the respective part of the mold 270, which results in a different twist angle α of the produced rotor blade in the region affected by tool 260. At the same time the height of the posts 320 is changed, also the support elements 340 have to be increased in height, such that the entire width of the relatively unstable mold 270 is sufficiently supported.

Support elements 340 may be realized in a number of ways. For illustrational purposes, they are only schematically shown in FIGS. 3 to 6. As an example, they may be realized as an interconnected grid of metal struts, of which a part may be length-adjusted such that the height of parts of the resulting structure can be modified. In another embodiment, the support elements 340 comprise a plurality of metal tubes protruding in a longitudinal direction of the mold, which are laminated to the mold. The tubes are supported by vertical struts supported by a steel frame.

If the twist angle α shall be varied in a different direction, the posts 320 are lowered instead of raised as shown in the previous example and in FIGS. 5 and 6. The respective side of the mold is lowered, such that angle α is modified accordingly.

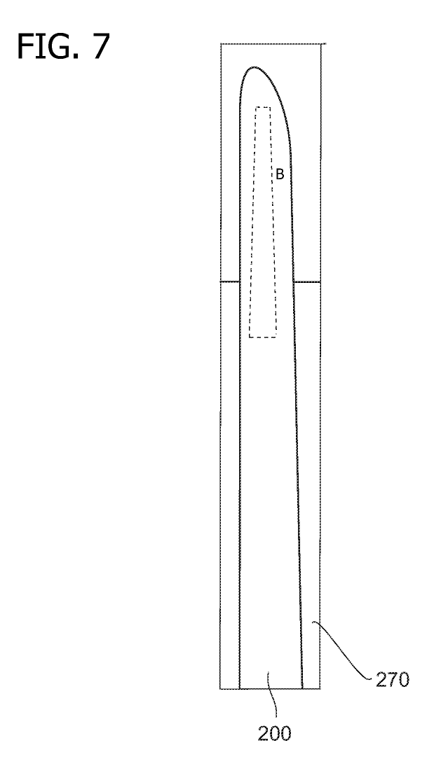

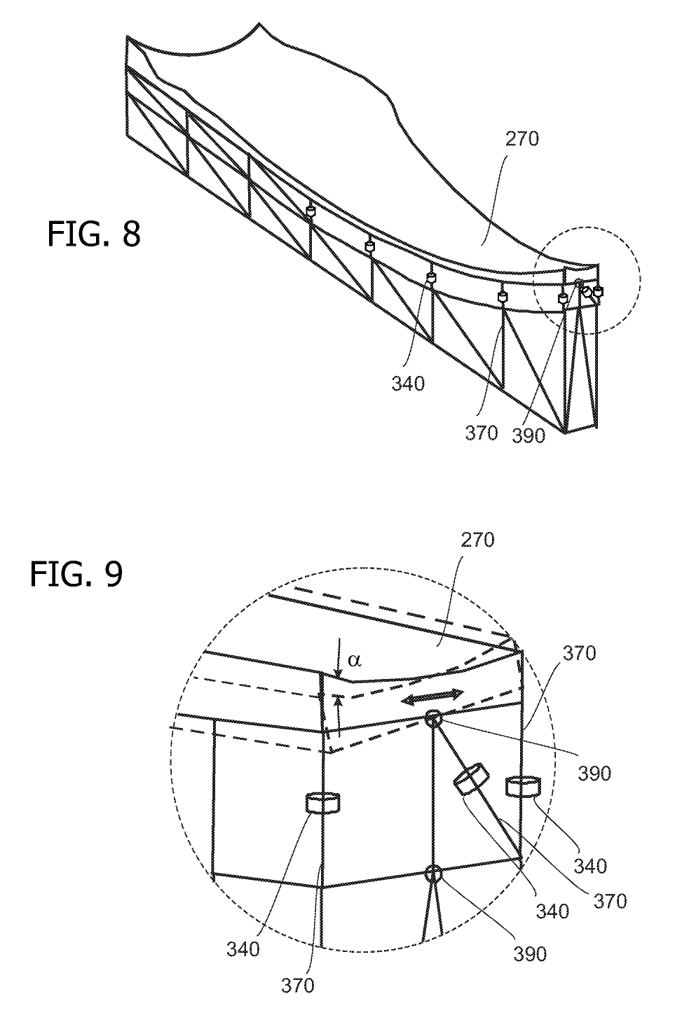

FIG. 7 shows a top view of a further embodiment. A sectional view cut out along dashed line B is shown in FIG. 8. In the embodiment, the adjustment of the twist angle is enabled via adjusting elements 340. These are located on struts 370 in a manner such that the struts are length-adjustable. In FIG. 9, a detailed sectional view of the exemplary embodiment of the support structure of FIG. 8 is shown. Therein, joints 390 enable the various supporting elements to move with respect to each other, when the adjusting elements 340 are adjusted in order change the twist angle. The dashed line symbolizes the outline of mold 270 with a twist angle modified by an angle α.

In embodiments, the adjusting mechanism typically affects a region which extends from a tip of the produced rotor blade up to about a length of one third of the rotor blade in the direction towards the root of the blade. Thereby, the range affected by the adjustment mechanism may start at the tip region of the blade, and may have a length in a direction of the produced rotor blade which is from one sixth of the blade length up to half of the blade length.

The above-described systems and methods facilitate an adjustment mechanism and method which provide an easy way to change a twist angle of an outermost part or region of the rotor blade during the production thereof.

Exemplary embodiments of systems and methods for a tool for producing a rotor blade are described above in detail. The systems and methods are not limited to the specific embodiments described herein, but rather, components of the systems and/or steps of the methods may be utilized independently and separately from other components and/or steps described herein. For example, the tool and methods may be applied for producing rotor blades not related to wind energy production, and are not limited to practice with only the wind turbine systems as described herein. Rather, the exemplary embodiment can be implemented and utilized in connection with many other rotor blade applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A tool for producing a rotor blade, comprising
a) at least one mold; and
b) at least one support structure for the at least one mold;
wherein the at least one mold is supported by the at least one support structure, and wherein the at least one support structure is adapted such that a twist angle of at least one portion of the at least one mold is adjustable.

2. The tool of claim 1, wherein the range of variation of the twist angle of at least a part of the at least one mold is from 0° to 20°.

3. The tool of claim 1, wherein the at least one supporting structure comprises at least one hinge.

4. The tool of claim 3, wherein the at least one hinge comprises an axis substantially parallel to a longitudinal axis of the at least one mold.

5. The tool of claim 3, wherein a part of the at least one mold is adapted to be turned about the at least one hinge.

6. The tool of claim 1, wherein the at least one supporting structure comprises at least one support element having variable length.

7. The tool of claim 1, wherein the at least one supporting structure comprises at least one strut.

8. The tool of claim 7, wherein the at least one supporting structure comprises a grid including at least one strut.

9. The tool of claim 7, wherein the length of at least one strut is adjustable.

10. The tool of claim 7, wherein at least one strut includes at least one adjustment element.

11. The tool of claim 7, wherein at least one strut comprises at least one joint.

12. The tool of claim 1, wherein the portion of the mold of which the twist angle is adaptable has a length from the tip end of the mold to a position which is from one fifth of the length of the mold up to half of the length of the mold.

13. The tool of claim 1, wherein the range of variation of the twist angle of at least a part of the at least one mold is from 0° to 10°.

14. A method for varying a twist angle of a part of a rotor blade, comprising:
a) providing a tool for producing a rotor blade, comprising
i) at least one mold; and
ii) at least one supporting structure for the at least one mold;
wherein the mold is supported by the support structure, and wherein the support structure is adapted such that a twist angle of at least one portion of the mold is adjustable;
b) adjusting the tool such that the twist angle of a portion of the mold is modified.

15. The method of claim 14, wherein adjusting the tool comprises increasing the height of one side of the mold.

16. The method of claim 14, wherein the modification of the twist angle is in a range from 0° to 20°.

17. The method of claim 14, wherein, during modifying a twist angle of a portion of the mold, a portion of the mold is turned about a hinge.

18. The method of claim 14, wherein adjusting the tool comprises modifying the length of at least one supporting element.

19. The method of claim 14, wherein one end of the at least one portion of the mold is at the tip end of the mold, and the other end of the portion is at a position which is from one fifth of the length of the mold up to half of the length of the mold.

20. The method of claim 14, wherein the tool allows an adjustment of twist angles along the entire length of the rotor blade.
